(19) United States
(12) Patent Application Publication
(10) Pub. No.: US 2015/0246834 A1
(43) Pub. Date: Sep. 3, 2015

(54) Method and system for control of an addition rate of a hexavalent chromium control chemical to water

(71) Applicant: Kemira Oyj, Helsinki (FI)

(72) Inventors: Roderick Abinet, Scottsdale, AZ (US); Greg Land, Yacolt, WA (US); David Soper, Gastonia, NC (US)

(73) Assignee: Kemira Oyj, Helsinki (FI)

(21) Appl. No.: 14/194,834

(22) Filed: Mar. 3, 2014

(51) Int. Cl. C02F 1/62; C02F 1/00

(52) U.S. Cl. CPC C02F 1/62; C02F 1/008

(57) ABSTRACT

The invention describes a method and system for controlling the addition rate of a contaminant control chemical to a water or wastewater line. The level of hexavalent chromium as a contaminant in the water or wastewater is measured using a spectro-photometric probe placed in the line. Data representative of the level of measured hexavalent chromium content is read into a computing unit, which determines a required contaminant control chemical addition rate based on said level of hexavalent chromium content. The contaminant control chemical is then added at the required addition rate to reduce the amount of hexavalent chromium to a predetermined level.

### FIELD OF THE INVENTION

The invention relates to the treatment of drinking water and wastewater. In particular, the invention relates to a method for controlling the addition rate of hexavalent chromium control chemicals dosed to a drinking water/wastewater treatment plant or distribution/sewer line. The invention also relates to a controlling system.

### BACKGROUND OF THE INVENTION

Hexavalent chromium (hereinafter Cr-6) dissolved in drinking water/wastewater poses a human health risk and is therefore regulated e.g. by the US Environmental Protection Agency. The maximum contaminant level goal (MCLG) for total chromium is 0.1 mg/L or 100 parts per billion (ppb). Chromium can exist in various oxidation states ranging from +6 to −2, but only the Cr-6 and trivalent chromium (hereinafter Cr-3) states commonly occur in the environment.

Chromium (Cr-3) is an essential human dietary element and occurs naturally in many vegetables, fruits, meats, grains and yeast. Cr-3 has relatively low toxicity and would be a concern in drinking water only at very high levels of contamination. However, both Cr-6 and Cr-3 are covered under the total chromium drinking water standard because these forms of chromium can convert back and forth in water and in the human body, depending on environmental conditions. Measuring just one form may not capture all of the chromium that is present. In order to ensure that the greatest potential risk is addressed, regulators assume that a measurement of total chromium is 100 percent chromium-6, the more toxic form.

Hexavalent chromium also occurs naturally in the environment, by erosion from natural chromium deposits, but it is also produced in industrial processes. There are demonstrated instances of chromium being released to the environment by leakage, poor storage, or inadequate industrial waste disposal practices. Cr-6 is toxic and poses potential health risks to humans. People who use water containing total chromium in excess of the maximum contaminant level (MCL) over many years could experience allergic dermatitis or cancer.

A known and effective treatment for chromium called Reduction/Coagulation/Direct Filtration (RCF), where considerable amounts of ferrous iron based coagulants are used to reduce the hexavalent chromium Cr-6 to less dangerous trivalent Cr-3. Cr-3 is then removed from the drinking water/wastewater by coagulation followed immediately by direct filtration.

Another approach for removing Chromium from water is to use ion exchange techniques, where the hexavalent chromium Cr-6 is captured on an anion exchange resin in filtration columns. The resulting trivalent chromium Cr-3 my then be filtrated as explained above.

Currently, the level of hexavalent chromium Cr-6 is measured by grab samples, using e.g. the US EPA Method 218.7 “Determination of Hexavalent Chromium in Drinking Water by ion Chromatography with Post-Column Derivatization and UV-Visible Spectroscopic Detection” (Version 1, November 2011).

This method provides procedures for the determination of hexavalent chromium as the chromate anion CrO₄²⁻ in finished drinking water using ion chromatography. These tests require specific equipment, take some time, and are typically analyzed after an alleged limit violation/incident has occurred.

This method, although accurate in principle, is not an on-line system providing real time results, and does thus not allow one to directly optimize feed rates to correspond to actual hexavalent chromium levels in pre- and/or post-treatment of the water.

In U.S. Pat. No. 5,292,435 is shown a process for removing chromium and other heavy metals from groundwater by adding approximately twice the theoretically necessary quantity of a ferrous salt to reduce the hexavalent chromium to trivalent chromium and to coprecitate the trivalent chromium with other heavy metals as hydroxides.

In U.S. Pat. No. 6,428,705 is shown a process for removing contaminants from large volumes of wastewater, where a wastewater stream containing contaminants are treated with a chemical coagulant, wherein the coagulant reacts with the contaminant to form a particulate or aggregate of particulates that has a size greater than about 10 μm. The treated wastewater is passed through a microfiltration membrane such that the contaminant is removed from the water and the contaminant may include also chromium (Cr).

Thus none of the known processes show a system that allows feedback from a measurement point to be fed to a chemical feeding station for direct optimization of chemical feed rates of chemicals necessary to reduce hexavalent chromium in pre- and/or post-treatment of the water. Accordingly, there exists a need for improved control methods and systems.

### SUMMARY OF THE INVENTION

It is an aim of the invention to solve at the abovementioned problem and to provide an improved method and system for controlling drinking water and wastewater flows with respect to hexavalent chromium levels.

The aim is achieved by the method and system according to the independent claims.

The invention provides significant advantages. Indeed, the inventors have found that a real-time hexavalent chromium level is the optimal parameter for the dosing of hexavalent chromium control chemicals, typically ferrous salts, properly. The present technology involves the use of a hexavalent chromium measurement device that will collect data and feed it back to a pump that can adjust iron salt feed for optimized contaminant control. The controlling is thus not anymore based on an indirect estimate or old grab sample but a real time measurement.

The invention provides a method of controlling the addition rate of a contaminant control chemical to a water or wastewater line comprising the steps of:
measuring a level of hexavalent chromium as a contaminant in the water or wastewater using a spectrophotometric probe placed in said line,
reading the data on the level of measured hexavalent chromium content into a computing unit,
determining in said computing unit a required contaminant control chemical addition rate based on said level of hexavalent chromium content,
adding said contaminant control chemical at the required addition rate to reduce the amount of hexavalent chromium to a predetermined level.

The rate control may be carried out in real time in response to said measuring, and the computing unit may be adapted to utilize a retention time caused by flow magnitude and water or wastewater line properties, when determining the required contaminant control chemical addition rate.

The measurement may include measuring the actual weight of hexavalent chromium in the water/wastewater line or a parameter correlating with said actual weight, and required contaminant control chemical addition rate is determined based on said actual weight or parameter correlating with said actual weight. The level of hexavalent chromium may be measured upstream or downstream of the addition point of the contaminant control chemical, or both.

In one embodiment the measuring, transferring, determining and instructing steps are arranged so as to provide an automatic feedback loop to said control unit, to drive the means for adding the contaminant control chemical. The computing unit may also be programmed to take into account contributions from other sources of hexavalent chromium situated downstream of the addition point of the contaminant control chemical.

In a preferred embodiment, the probe that is used is capable of providing a signal which is relative to hexavalent chromium weight in the water/wastewater flow.

A contaminant control chemical used may comprise an iron salt, where the weight ratio of hexavalent chromium to elemental iron in the iron salt is calculated for determining the required contaminant control chemical addition rate. The iron salt may be selected from the group of Ferrous Chloride, Ferric Chloride, blend of Ferrous/Ferric Chloride, Ferrous Sulfate, Ferric Sulfate, blend of Ferrous/Ferric Sulfate, Ferric Nitrate, or other blend thereof. Preferably, the contaminant control chemical is FeSO4 or FeCl2.

In an embodiment of the invention, the pH value in the water or wastewater is measured, and the pH value is taken into account in the control unit when determining the required addition rate of the contaminant control chemical. A non-linear formula may be used for determining the contaminant control chemical addition rate based on the level of hexavalent chromium. The required contaminant control chemical addition rate is determined so as to bring the level of hexavalent chromium to at least a level of less than 100 ppb, in particular less than 10 ppb, preferably less than 5 ppb in the water or wastewater line. The contaminant control chemical may be added into a mixing sleeve in the wastewater line.

According to the invention, the required contaminant control chemical addition rate to measured hexavalent chromium level ratio is progressively increased with a decreasing level of hexavalent chromium, the ratio preferably being less than 10:1 with at least a first hexavalent chromium level and more than 80:1 with at least a second hexavalent chromium level smaller than the first dissolved hexavalent chromium level.

The hexavalent chromium content may be measured by a probe placed in vitro, directly into the flow of water/wastewater, or by a probe placed outside the water/wastewater flow with intermittent pumping of samples over the probe.

The invention also relates to a system for controlling addition rate of a contaminant control chemical to a water or wastewater line, the system comprising
means for measuring a level of hexavalent chromium in the water or wastewater line using a spectrophotometric probe placed in said line,
a computing unit for receiving measurement data on the level of measured hexavalent chromium content and for determining a required contaminant control chemical addition rate,
means for adding contaminant control chemical to the water or wastewater line at the required addition rate to reduce the amount of hexavalent chromium to a predetermined level.

The invention is in the following described in detail by means of examples and by referring to the attached drawings.

### BRIEF DESCRIPTION OF THE DRAWINGS

FIG. 1 shows a schematic illustration of one embodiment of the invention.

FIG. 2 shows a schematic illustration of another embodiment of the invention.

FIG. 3 shows UV-absorption spectra of K₂Cr₂O₇ at three different pH levels;

FIG. 4 shows UV-absorption spectra of water before and after treatment with ferrous sulphate;

FIG. 5 shows a flowchart of an example dosage calculation;

FIG. 6 shows a schematic illustration of a further embodiment of the invention.

### DETAILED DESCRIPTION OF EMBODIMENTS

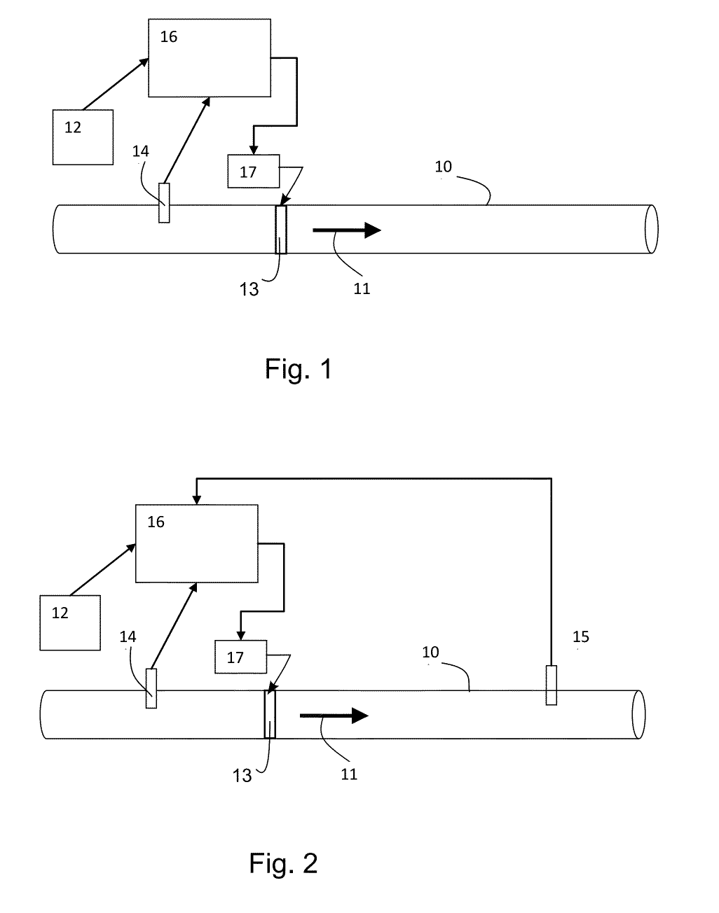

With reference to FIG. 1, and as briefly discussed above, the present method is here applied in a wastewater treatment plant or sewer line 10 comprising means 17 for adding hexavalent chromium control chemical to the wastewater stream 11. The contaminant control chemical is added into a mixing sleeve 13 in the water/wastewater line 10. The wastewater line 10 can be a municipal/industrial main line or a branch/root line. Usually, the line is a large line where the total flow amounts to between at least 1-20 million litres/day.

The present system is primarily designed to regulate the chemical dose rate applied to a water/wastewater stream for treatment of carcinogenic hexavalent chromium levels at a certain point of the line downstream or upstream the dosing point. In FIG. 1 is shown measurement of the level of hexavalent chromium in the wastewater line using a hexavalent chromium probe 14 placed upstream in the wastewater line. This allows for predictive control of chemical addition. The probe provides a signal, e.g. via an ethernet cable to an electronic box display, which is proportional to the true weight (per volume) of the hexavalent chromium content of the wastewater stream. The signal is transferred via cable or wirelessly to a computing unit 16, such as a general industrial process control computer or SCADA (Supervisory Control and Data Acquisition) unit. Other parameters descriptive of the wastewater stream for the computing unit may be provided also from respective measurement units, denoted with a reference numeral 12.

The probe may be based on spectrophotometer technology. The measurement principle of the probe is preferably UV-spectrometry. A suitable probe is an s::can spectro::lyser™ probe, which can be mounted to a wastewater line quite easily under almost any conditions. The probe may be placed in vitro, i.e. directly into the flow of wastewater, or the probes can be placed outside the flow with intermittent pumping of raw and/or treated samples over the probes. Preferably, the measurement is carried out using a hexavalent chromium measurement probe capable of providing a signal which is relative to hexavalent chromium weight (including weight per volume) in the wastewater flow. Weight-based measurements provide very accurate information for evaluation of the contaminant control chemical need.

The computing unit 16 is programmed, using suitable software, to determine a required contaminant control chemical addition rate based on said level of hexavalent chromium. For this purpose, there is a suitable algorithm coded in the software. The computing unit 16 is adapted to provide an electric signal instructing the means 17 for adding hexavalent chromium control chemical at said required addition rate to the wastewater stream 11. The signal may be a provided through an analog hard wire or modbus to a pump controller. The pumps may be equipped with a mag-flow meter that automatically reads the chemical feed output. This output is fed back to the computing unit 16 and is used to track the targeted (calculated) dosage for accuracy.

The control target value is suitably chosen, e.g. to bring the amount of hexavalent chromium to an acceptable level. The target chosen naturally also affects the amount of chemical required.

Preferably the computing unit is adapted to set the addition rate to a level that brings the level of hexavalent chromium to a level of less than 10 ppb, in particular less than 5 ppb in the wastewater line. In terms of concentration, a preferred target range for hexavalent chromium is less than 5 ppb (μg/l), in particular less than 1 ppb μg/l. The contaminant control chemicals may include iron salt. The iron salt is selected from the group of ferrous chloride, ferric chloride, blends of ferrous/ferric chloride, ferrous sulfate, ferric sulfate, blends of ferrous/ferric sulfate, ferric nitrate, or other blends thereof. Preferably the contaminant control chemical is FeSO4 and/or FeCl2. In this case the weight ratio of hexavalent chromium to the elemental iron in the iron salt is decisive when evaluating the iron salt need.

The computing unit may be programmed to take into account any side stream hexavalent chromium contributions generated downstream of the addition point of the contaminant control chemical. This usually involves the addition of the contaminant control chemical at a rate which is higher than the direct measurement would indicate. The factor may be 1.2 or higher.

The computing unit may be adapted to determine the required contaminant control chemical addition rate so as to be at least 7 times greater than the measured level of—hexavalent chromium (weight to weight ratio of active salt, e.g. FeCl2 to Cr VI levels. Such considerations are important especially in wastewater lines, as ferrous Iron (Fe2⁺) will preferentially choose sulfides forming FeS and FeS₂ first, over other contaminants such as hexavalent chromium. The computing unit may be adapted to use a non-linear formula for determining the contaminant control chemical addition rate based on the level of hexavalent chromium. Algorithms may be intended for predictive treatment or for providing a fast response to changing contaminant content in the water, and must thus be designed accordingly. In particular for wastewater, the required contaminant control chemical addition rate to measured hexavalent chromium level ratio (weight to weight) may be affected by other ferrous sulfide-consuming contaminants in the water. In some cases, it may need to be progressively increased with decreasing level of hexavalent chromium, the ratio being preferably less than 10:1 with at least a first hexavalent chromium level and more than 80:1 with at least a second hexavalent chromium level smaller than the first hexavalent chromium level.

Additional parameters which may be needed in the general case of controlling the addition rate of a hexavalent chromium control chemical to water, that are typically needed for accurate control, include current flow magnitude of the water/wastewater stream, the pH of the water/wastewater stream, biochemical oxygen demand (BOD) levels, the temperature of the water/wastewater stream and the composition of the hexavalent chromium control chemical used. Some or all of these parameters may be used. If the pH is expected to be constant, no separate pH measurement is needed. However, if pH is fluctuating, an additional pH probe is required for compensation. In all, the inventive method may comprise measuring the pH, temperature and/or total flow of water/wastewater, and taking into account the pH, temperature and/or total flow of water/wastewater in the control unit when determining the required addition rate of the contaminant control chemical.

The system preferably includes means for sending the measurement data of the measurement probe through a wired connection or over a wireless channel to a database server for analysis and processing in real time.

The measuring step can be repeated at constant or non-constant time intervals which typically do not exceed 30 minutes, being most typically 10 minutes or less. Of course, the measurement can be also continuous, but there is typically no need for this at least in main water/wastewater lines, where the fluctuations of water/wastewater composition are relatively slow. The actual controlling, i.e. dose determination and dosing, is carried out in real time in response to the measuring. The term “real time” as herein used covers a time delays less than 60 minutes, which is a considerably shorter delay and in known prior art methods. Typically, the delay is of the order of 0-5 minutes.

The retention time of the chemical reactions involved is important when determining the required contaminant control chemical addition rate. Thus, the system accounts for the delay when the reactions between hexavalent chromium and the iron salt take place. This improves the accuracy of control. The retention time can be estimated based on the flow magnitude and water/wastewater line volumes and properties.

The measurement point of the level of hexavalent chromium may also be downstream, using a downstream measurement probe 15, of the addition point of the contaminant control chemical. This is shown in FIG. 2. The downstream measurement point should be located far enough away from the addition point to ensure sufficient mixing time of dissolved iron Fe2+ and hexavalent chromium. Mixing can occur within minutes or hours, depending on the amounts of the components.

Of course there may be measurement points both upstream and downstream of the addition point of the contaminant control chemical. With a measurement point located downstream of the addition point, the controlling can be implemented using a feedback loop. Thus, at least some of the changes caused by the contaminant control chemical in the composition of the water/wastewater are detected by the probe and the changes are taken into account in the computing unit for driving the means for adding the contaminant control chemical. This is especially important when optimizing the iron salt addition consisting of ferrous Iron (Fe2+) that will reduce Cr (VI) to Cr (III). Adding excessive Ferrous Iron requires an additional oxidation step, to ensure no dissolved iron leaves the treatment process. This results in higher treatment costs. Also, a secondary UV Spectrophotometer probe can be placed downstream of the treatment points to ensure levels of hexavalent chromium are dramatically reduced or completely eliminated.

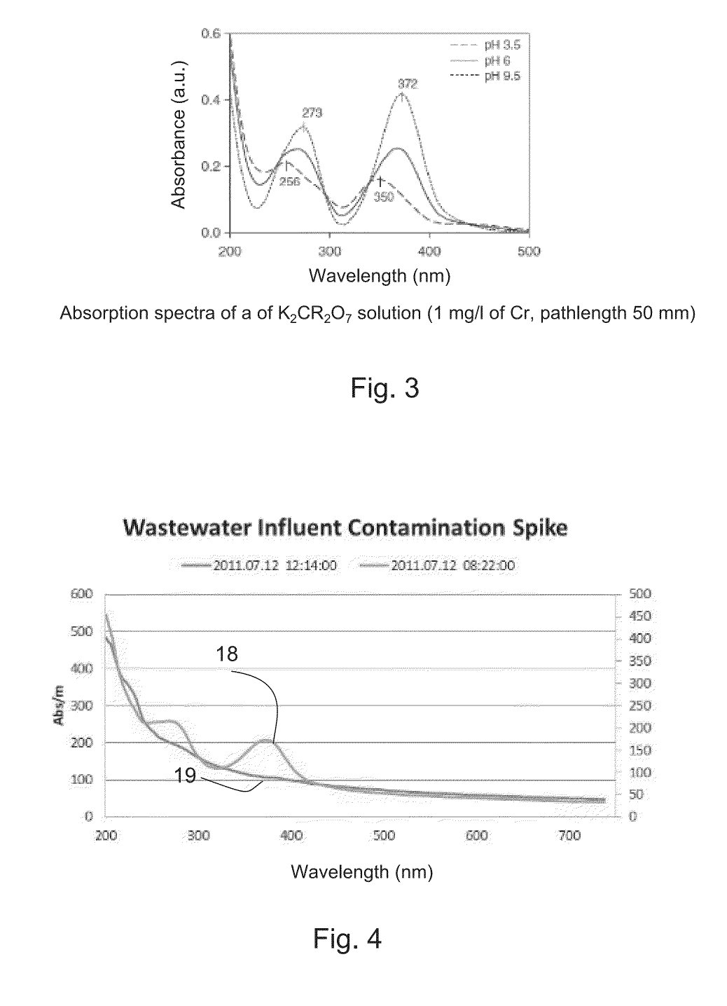

A probe can thus detect hexavalent Chromium UV spectrum absorbance peaks, and the intensity of the signal that has been calibrated in laboratory to correspond the amount of chromate ion can be used to determine the actual weight of hexavalent Chromium in the water, and to automatically calculate an iron salt dosage level based on a specified algorithm. As shown in the UV-absorption spectra of K₂Cr₂O₇ of FIG. 3, made at three different pH levels 3.5, 6 and 9.5, the distinct peaks are present at all pH ranges, but the place and height of spectrum peaks varies slightly depending on the pH value.

In FIG. 4 is shown a UV-spectrometry analysis of hexavalent Chromium in the form K₂Cr₂O₇, as measured with a spectro::lyser™ probe that placed directly in a water or wastewater flow being in constantly connection with a spectrophotometer device. The probe can be mounted quite easily under almost any conditions. Here, the pH was kept constant at a value of 6. If pH is fluctuating, an additional pH probe may be required for compensation. The hexavalent Chromium shows a distinct absorbance UV spectrum peaks at around 260 and 370 nm on the graph 18 representing untreated water. The graph 19 representing treated water (having a later timestamp) shows no such peaks.

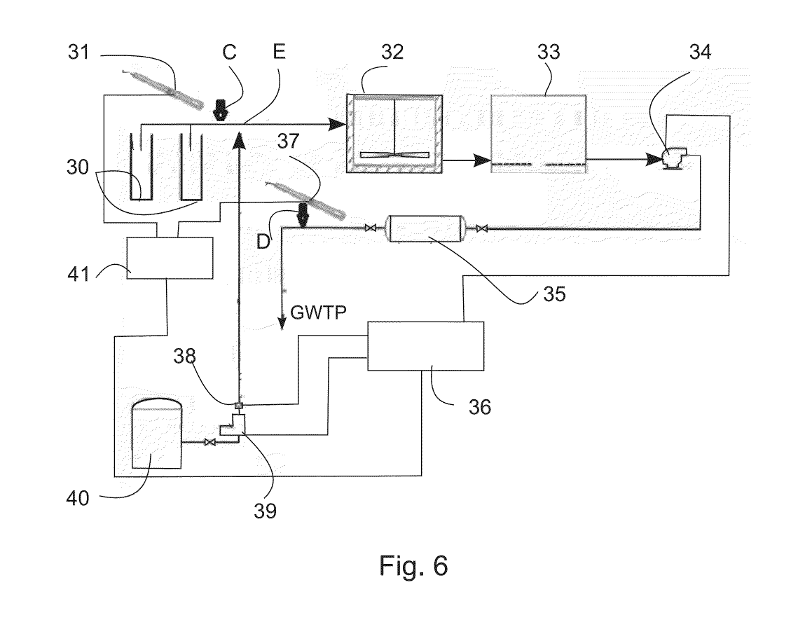

Referring now to FIG. 6, a simplified process plant for treating household and/or drinking water according to one embodiment of the present invention is shown. The water line in the plant includes extraction wells 30, from which water to be treated are fed to a reduction tank and a mixer 32, to an aerator chamber 33 and further to one or several pumps 34. From the pump the water is transferred to a filter 35, which may include customary backwash water inlets and outlets for sludge being removed from the water. These are not shown, as being outside the scope of the present invention. From the filter 35 the water transfers to a ground water treatment plant (GWTP). At points C and D, recycled backwash water from filter 35 may be inserted in the water flow. A first probe 31 is measuring the amount of soluble hexavalent chromium (Cr VI) amount at point C. From a ferrous sulfate storage tank 40 via a pump 39, liquid containing ferrous sulfate is added to the water line at point E. At a downstream point D, the amount of soluble Cr VI is again measured with a second probe 37. In other embodiments of the invention, the probe 31 or 37 may also be the only probe at their measurement points in the process, as discussed in connection with FIG. 2.

The measurement at point D provides feedback information for the dosage of the ferrous sulfate at point E. The amount of ferrous sulfate is measured at 38 with a device that can be e.g. a magnetic flow meter, as the flow from the tank 40 contains iron. The data reading from the flow meter 38 and the immediate control of the pump 39 is performed by e.g. a programmable logic circuit (PLC) 36. The PLC 36 also receives quantitative information on the actual water flow, e.g. water pressure, from pump 34. The PLC circuit 36 communicates via wire or wirelessly with a process computer 41, which reads data from the probes 31 and 37 and according to a given algorithm, evaluates the feedback information from probe 37 to determine the dosage of ferrous sulfate from tank 40 and pump 39.

### EXAMPLE

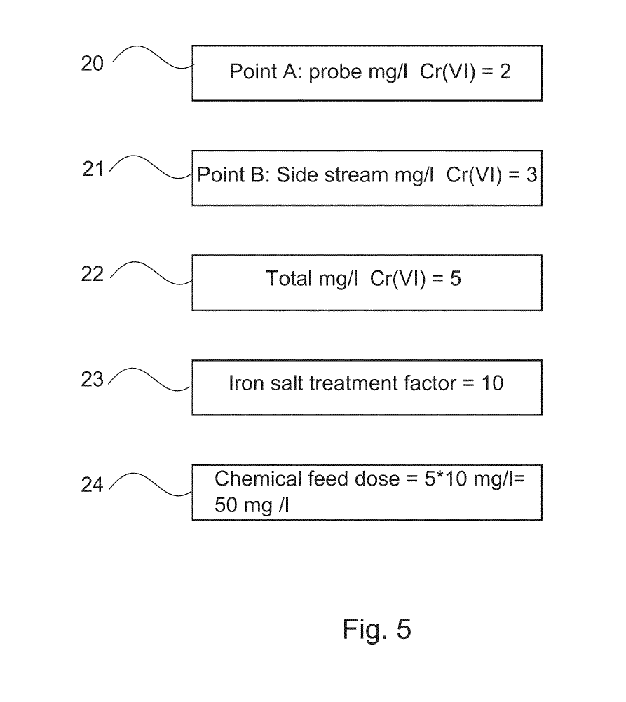

Referring now to FIG. 5, an example of how to measure the chemical feed dose to a liter water/wastewater line is described. At 20, a probe is used to measure the soluble hexavalent chromium (Cr VI) amount at certain measurement point A. This amount, the actual weight of CR(VI), may be expressed as an mg/l value (milligrams soluble Cr(VI) per liter water/wastewater, =“probe mg/l Cr(VI)”). This value is automatically fed to a programmable logic controller (PLC) at predefined intervals (e.g. 5 minute intervals). The example value is “2”.

The mg/l soluble Cr(VI) contributed at a later (downstream) point B by side streams residing between point A and point B has at 21 been predetermined by field measurements (=“side stream mg/l Cr(VI)”). This value is also fed to the same programmable logic controller. An example value is “3”.

At 22, the total mg/l soluble Cr(VI) required for treatment is calculated: Probe mg0/l Cr(VI)+side stream mg/l Cr(VI). The example value is thus “5”.

The required mg/l of iron salt per mg/l soluble Cr(VI) value has been predetermined in laboratory at 23. This is the (treatment factor multiple). This is also entered into PLC. The example value is “10”.

The chemical feed dose is then automatically calculated at 24 e.g. every time the probe samples the mg/l soluble Cr(VI) at point A at 20. Using the example values indicated, the chemical dose required is calculated as the total mg/l soluble Cr(VI) X treatment factor=5*10=50 mg/l. The appropriate

The required volume per minute amount of iron salt is then calculated to meet these parameters using input from a total line flow measuring device, and sent to an iron salt feed pump speed controller.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention.

Accordingly, it is not intended that the invention be limited, except as by the claims set forth below.

1. A method of controlling the addition rate of a contaminant control chemical to a water or wastewater line, the method comprising:
measuring a level of hexavalent chromium as a contaminant in the water or wastewater using a spectrophotometric probe placed in said line,
reading the data on the level of measured hexavalent chromium content into a computing unit,
determining in said computing unit a required contaminant control chemical addition rate based on said level of hexavalent chromium content,
adding said contaminant control chemical at the required addition rate to reduce the amount of hexavalent chromium to a predetermined level.

2. A method according to claim 1, wherein said rate control is carried out in real time in response to said measuring.

3. A method according to claim 1, wherein the computing unit is adapted to utilize a retention time caused by flow magnitude and water or wastewater line properties, when determining the required contaminant control chemical addition rate.

4. A method according to claim 1, wherein the measurement comprises:
measuring the actual weight of hexavalent chromium in the water/wastewater line or a parameter correlating with said actual weight, and
determining the required contaminant control chemical addition rate based on said actual weight or parameter correlating with said actual weight.

5. A method according to claim 1, further, comprising measuring the level of hexavalent chromium upstream of the addition point of the contaminant control chemical.

6. A method according to claim 1, further
comprising measuring the level of hexavalent chromium downstream of the addition point of the contaminant control chemical.

7. A method according to claim 6, wherein the measuring, transferring, determining and instructing steps are arranged so as to provide an automatic feedback loop to said control unit, to drive the means for adding the contaminant control chemical.

8. A method according to claim 1, wherein the computing unit is programmed to take into account contributions from other sources of hexavalent chromium situated downstream of the addition point of the contaminant control chemical.

9. A method according to claim 1, wherein the probe is capable of providing a signal which is relative to hexavalent chromium weight in the water/wastewater flow.

10. A method according to claim 1, wherein the contaminant control chemical comprises an iron salt.

11. A method according to claim 10, wherein the weight ratio of hexavalent chromium to elemental iron in the iron salt is calculated for determining the required contaminant control chemical addition rate.

12. A method according to claim 10, wherein the iron salt is selected from the group of Ferrous Chloride, Ferric Chloride, blend of Ferrous/Ferric Chloride, Ferrous Sulfate, Ferric Sulfate, blend of Ferrous/Ferric Sulfate, Ferric Nitrate, or other blend thereof

13. A method according to claim 12, wherein the contaminant control chemical is FeSO4 and/or FeCl2.

14. A method according to claim 1, further comprising measuring the pH value in the water or wastewater and taking into account the pH value in the control unit when determining the required addition rate of the contaminant control chemical.

15. A method according to claim 1, wherein computing unit is adapted to use a non-linear formula for determining the contaminant control chemical addition rate based on the level of hexavalent chromium.

16. A method according to claim 1, wherein the contaminant control chemical added into a mixing sleeve in the wastewater line.

17. A method according to claim 1, wherein the required contaminant control chemical addition rate is determined so as to bring the level of hexavalent chromium to at least a level of less than 100 ppb in the water or wastewater line.

18. A method according to claim 1, wherein the required contaminant control chemical addition rate to measured hexavalent chromium level ratio is progressively increased with a decreasing level of hexavalent chromium.

19. The method according to claim 1, wherein the hexavalent chromium content is measured by a probe placed in vitro, directly into the flow of water/wastewater.

20. The method according to claim 1, wherein the water/wastewater hexavalent chromium content is measured by a probe placed outside the water/wastewater flow with intermittent pumping of samples over the probe.

21. A system for controlling addition rate of a contaminant control chemical to a water or wastewater line, the system comprising:
means for measuring a level of hexavalent chromium in the water or wastewater line using a spectrophotometric probe placed in said line,
a computing unit for receiving measurement data on the level of measured hexavalent chromium content and for determining a required contaminant control chemical addition rate, and
means for adding contaminant control chemical to the water or wastewater line at the required addition rate to reduce the amount of hexavalent chromium to a predetermined level.

22. A system according to claim 21, wherein the probe is placed in vitro;
directly into the flow of water or wastewater.

23. A system according claim 21, wherein the probe is placed outside the water or wastewater flow and provided with intermittent pumping of samples over the probe.

24. A system according to claim 21, further comprising means for measuring the level of hexavalent chromium upstream of the addition point of the contaminant control chemical.

25. A system according claim 21, further comprising measuring the level of hexavalent chromium downstream of the addition point of the contaminant control chemical.

26. A system according to claim 25, wherein the measuring, transferring, determining and instructing steps are arranged so as to provide an automatic feedback loop to said control unit, to drive the means for adding the contaminant control chemical.
